(19) United States
(12) Patent Application Publication
(10) Pub. No.: US 2026/0330741 A1
(43) Pub. Date: Oct. 22, 2026

(54) HYBRID POWER DELIVERY-BASED GRAPHICS PROCESSING UNIT (GPU) ARCHITECTURE

(71) Applicant: QUALCOMM Incorporated, San Diego, CA (US)

(72) Inventors: Nilanjan GOSWAMI, Livermore, CA (US); Dam BACKER, San Diego, CA (US); Brian ELLIS, San Diego, CA (US)

(21) Appl. No.: 19/181,200

(22) Filed: Apr. 16, 2025

(51) Int. Cl. G06T 15/00

(52) U.S. Cl. CPC G06T 15/005

(57) ABSTRACT

A graphics processing unit (GPU) apparatus has a number of graphics processing blocks operating in a high power domain. The apparatus also has a subset of the graphics processing blocks operating in a low power domain to provide a functional subset of graphics rendering capabilities. A method for processing with a graphics processing unit (GPU) apparatus includes supplying a high voltage to a number of graphics processing blocks operating in a high power domain. The method also includes supplying a low voltage to a subset of the number of graphics processing blocks operating in a low power domain to provide a functional subset of graphics rendering capabilities. The method may also include supplying the high voltage to the subset of the graphics processing blocks to operate in the high power domain

### BACKGROUND

### Field

Aspects of the present disclosure relate to computing devices, and more specifically to hybrid power delivery-based graphics processing unit (GPU) architecture for ultra-low power devices.

### Background

Mobile or portable computing devices include mobile phones, laptop, palmtop and tablet computers, portable digital assistants (PDAs), portable game consoles, extended reality (XR) devices (including augmented reality (AR), mixed reality (MR), and virtual reality (VR) devices), and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others. It would be desirable to improve power efficiency of these devices, especially for ultra-low power devices.

### SUMMARY

Aspects of the present disclosure are directed to a graphics processing unit (GPU) apparatus. The apparatus has a number of graphics processing blocks operating in a high power domain. The apparatus also has a subset of the graphics processing blocks operating in a low power domain to provide a functional subset of graphics rendering capabilities.

In other aspects of the present disclosure, a method for processing with a graphics processing unit (GPU) apparatus includes supplying a high voltage to a number of graphics processing blocks operating in a high power domain. The method also includes supplying a low voltage to a subset of the graphics processing blocks operating in a low power domain to provide a functional subset of graphics rendering capabilities.

Other aspects of the present disclosure are directed to a graphics processing unit (GPU) apparatus. The apparatus has one or more memories and one or more processors coupled to the one or more memories. The apparatus is configured to supply a high voltage to a number of graphics processing blocks operating in a high power domain. The apparatus is also configured to supply a low voltage to a subset of the number of graphics processing blocks operating in a low power domain to provide a functional subset of graphics rendering capabilities.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a three-dimensional (3D) graphics processing unit (GPU)-based system, in accordance with certain aspects of the present disclosure.

FIG. 2 is a block diagram illustrating hardware and software for a hybrid power delivery GPU-based system, in accordance with various aspects of the present disclosure.

FIG. 3 is a flow diagram illustrating an example process performed, for example, by a 3D GPU-based system, in accordance with various aspects of the present disclosure.

FIG. 4 is a block diagram showing an exemplary wireless communications system in which a configuration of the present disclosure may be advantageously employed.

FIG. 5 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

A graphics processing unit (GPU) performs a variety of tasks. For example, a GPU may render relatively simple graphics, such as two-dimensional (2D) text, or more complex graphics, such as a three-dimensional (3D) images with shading, or a mix of both complex and simple graphics. Power specifications for the different types of rendering vary, with relatively higher power consumption specified for the complex graphics and lower power consumption for the simple graphics.

Ultra-low power consumption is specified for wearable devices, such as extended reality (XR) devices, including augmented reality (AR) devices. Wearable technology, such as AR devices, operate with extremely low power consumption to ensure efficient application execution. This low power consumption is crucial for maintaining the functionality and usability of these devices throughout the day, without frequent recharging.

Low power islands (LPI) may be implemented for efficient processing. Low power islands help wearable devices achieve ultra-low power rendering by relying on low power application processors, memory, and other processing elements that are part of a specific power management area known as the “low power island.” The low power island contrasts with a “nominal power island,” which powers the entire system-on-a-chip (SoC). The low power island is designed to handle tasks with high usage that require less power, thereby extending the battery life of the device.

Aspects of the present disclosure introduce a GPU-based system with multiple power domains. The GPU-based system includes a hybrid GPU with graphics processing blocks, such as 3D rendering specific blocks, running at a nominal power level and a subset of the graphics processing blocks, such as 3D/2D rendering specific blocks, capable of running in a low power island. According to aspects of the present disclosure, dynamic switching occurs between the low power island components and the nominal power island components. When operating the blocks in the low power island with an application programming interface (API) subset, power gating of the nominal power island hardware and in addition the transformation of some portions of the nominal power island components to operate on low power island mode occur to enable power savings. Some portions of the logic operate with both low power and nominal power, although not low power and nominal power at the same time.

Particular aspects of the subject matter described in this disclosure can be implemented to realize one or more of the following potential advantages. In some examples, the described techniques, such as a GPU system with multiple power domains, enables power savings. A unified GPU solution streamlines the system, enhancing efficiency and performance, while also reducing costs.

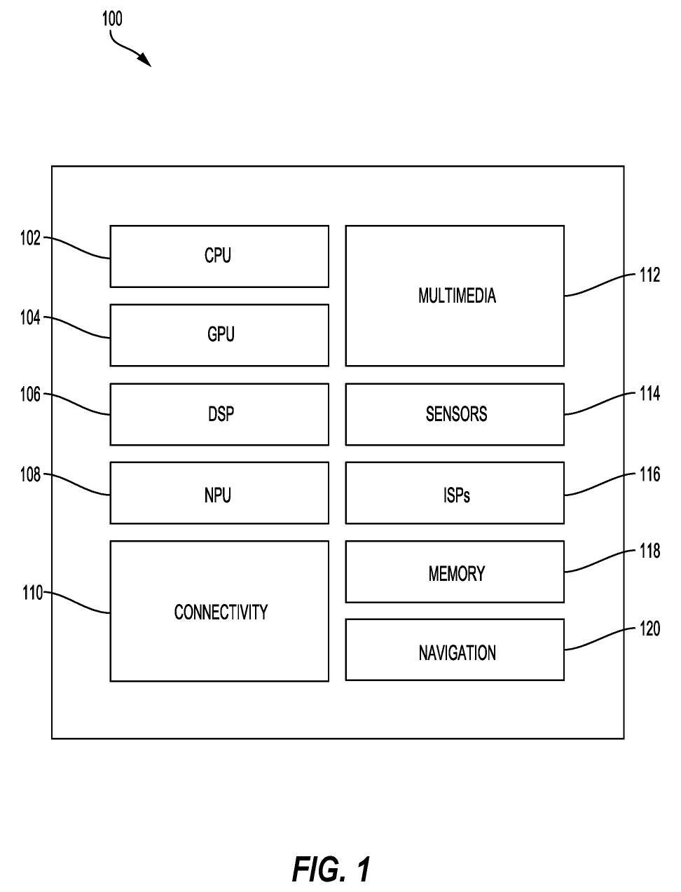

FIG. 1 illustrates an example implementation of a host system-on-a-chip (SoC) 100, which includes a three-dimensional (3D) graphics processing unit (GPU)-based system, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

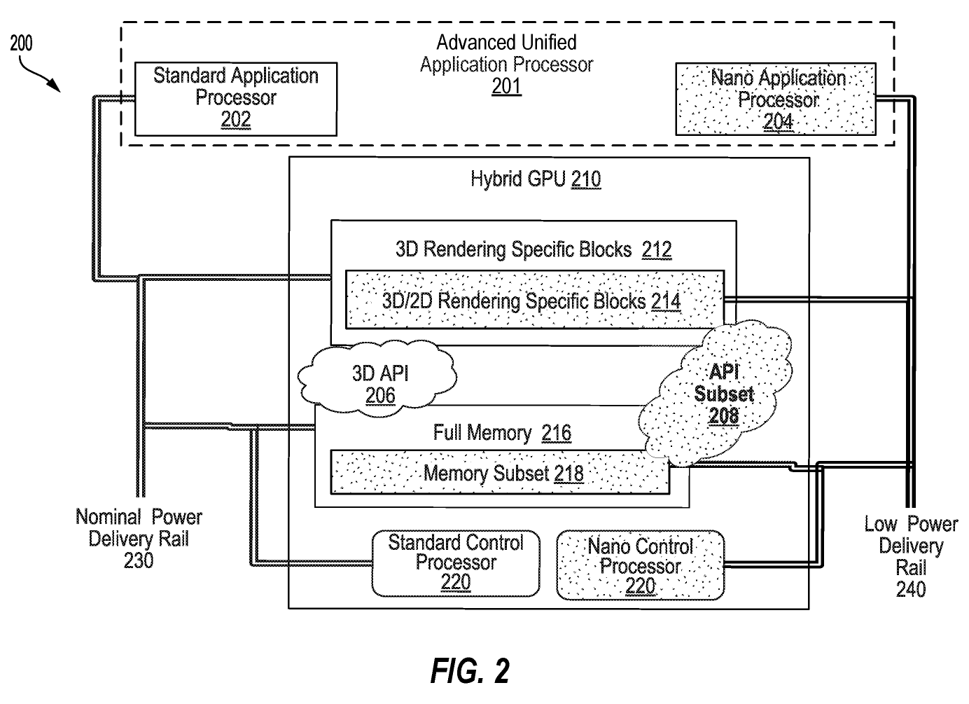

According to aspects of the present disclosure, a mobile device includes a hybrid power deliver GPU-based system. The GPU-based system may include means for supplying, means for switching, and means for communicating. In one configuration, the supplying means, the switching means, and the communicating means may be the GPU 104, hybrid GPU 210, nominal power deliver rail 230, low power delivery rail 240, standard application processor 202, nano application processor 204, standard control processor 220, nano control processor 220, 3D API 206, and/or API subset 208, as shown in FIGS. 1 and 2. In other aspects, the aforementioned means may be any structure or any material configured to perform the functions recited by the aforementioned means.

A graphics processing unit (GPU) performs a variety of tasks. For example, a GPU may render relatively simple graphics, such as two-dimensional (2D) text, or more complex graphics, such as a three-dimensional (3D) images with shading. Power specifications for the different types of rendering vary, with higher power consumption specified for the complex graphics and lower power consumption for the simple graphics.

Ultra-low power consumption is specified for wearable devices, such as extended reality (XR) devices, including augmented reality (AR) devices. Wearable technology, such as AR devices, operate with extremely low power consumption to ensure efficient application execution. This low power consumption is crucial for maintaining the functionality and usability of these devices throughout the day, without frequent recharging.

Some applications have limited rendering needs. For example, everyday applications such as clock faces on smartwatches, notifications on smart glasses or watches, messaging applications, and navigation tools generally do not need the high rendering capabilities of a 3D GPU. Instead, these applications can run efficiently on ultra-low power 2D GPUs. Running 2D GPUs allows for use of the devices for extended periods without needing to recharge. In some cases, a product design itself may not be feasible without such 2D GPUs.

A multi-GPU system may include a 2D GPU and a 3D GPU. Multi-GPU systems include an ad-hoc GPU with a proprietary software stack, not having standard technologies such as OpenVG ® available from Khronos Group, Inc. of Beaverton Oregon, Scalable Vector Graphics (SVG ®) from W3C of Wakefield, MA, or Vulkan ® available from Khronos Group, Inc. of Beaverton Oregon. Multi-GPU systems present challenges in terms of system management and scalability. It would be more advantageous if these multi-GPU systems supported standard protocols that are easily integrable with existing software ecosystems, making the GPUs easier to manage and update over time.

A single GPU solution may lead to reductions in both the physical area and power consumption of the overall system. A unified GPU solution would streamline the system, enhancing efficiency and performance.

Aspects of the present disclosure introduce a GPU-based system with multiple power domains. FIG. 2 is a block diagram illustrating hardware and software for a hybrid power delivery GPU-based system 200, in accordance with various aspects of the present disclosure. The GPU-based system 200 includes a GPU with a low power island, a nominal power island, and with a power island that can run efficiently with both low and high power delivery.

In some aspects, the GPU-based system 200 includes an advanced unified application processor (AP) 201 with a standard application processor 202 and a lightweight (or nano) application processor 204. The nano AP 204 is smaller than the standard AP 202 and has fewer capabilities, but is more power efficient. The nano AP 204 may be an ultra-low power microprocessor, whereas the standard AP 202 may be a CPU, such as the CPU 102 of FIG. 1.

Software for the low power island 3D GPU-based system 200 may include a driver and compiler for a RISC-V-based system. A standard 3D application programming interface (API) 206, such as a VULKAN API, may be provided for nominal power processing. A trimmed down version or subset of the standard 3D API 206 (API subset 208) may be used for less complex rendering during low power island operation. By generating the API subset 208 as a subset of the standard 3DAPI 206, software driver architecture may be simplified.

In a first stage of creating the API subset 208, an existing software stack (e.g., the standard 3D API 206) may be migrated to be low power island compatible. Power optimization does not occur in the first stage. Example migration steps may include supplementing a subset of the API functionality sufficient to render low power cases with a 2D graphics library. For example, a SKIA graphics engine, available from Google of Mountain View, CA, may be implemented with a backend including a VULKAN subset for only 2D rendering. In a second stage, a portion of the existing stack (e.g., the standard 3D API 206) may be power optimized. For example, a subset of the VULKAN app (e.g., SKIA with a VULKAN backend) may be optimized to reduce power consumption.

The low power island 3D GPU-based system 200 includes a hybrid GPU 210 with graphics processing blocks, such as 3D rendering specific blocks 212, running at the nominal power level and a subset of the graphics processing blocks, such as 3D/2D rendering specific blocks 214, capable of running in the low power mode as well as the nominal power mode. Examples of functions of the 3D/2D rendering specific blocks 214 (which may include 2D functions and 3D functions) are: binning, blending, rasterizing, vertex processing, and a limited set of shader functionality. A limited set of shader functionality may include fixed functions offered to a calling application, such as bump mapping. Examples of functions of the 3D rendering specific blocks 212 include advanced 3D graphics features, such as a majority of shading functionality, low resolution Z-buffering, advanced texture mapping, graphics memory management, etc. A full memory 216 is associated with the 3D rendering specific blocks 212. A memory subset 218 in the low power domain is associated with the 3D/2D rendering specific blocks 214.

A standard control processor (CP) 220 may be configured for the nominal power operations. The standard CP 220 may be a RISC-V control processor, in some implementations. A separate lightweight (e.g.., nano) control processor 222 is optionally configured for the low power island operations. The nano CP 222 is smaller than the standard CP 220 and has fewer capabilities, but is more power efficient.

The standard 3D API 206 operates with the standard AP 202, 3D rendering specific blocks 212, full memory 216, standard CP 220, nano AP 204, 3D/2D rendering specific blocks 214, memory subset 218, and the nano CP 222. The API subset 208 operates with the nano AP 204, 3D/2D rendering specific blocks 214, memory subset 218, and nano CP 222.

According to aspects of the present disclosure, dynamic switching occurs between the low power island components and the nominal power island components. When operating the blocks in the low power island with the API subset 208, power gating of the nominal power island hardware occurs to enable power savings. In some aspects during nominal power mode operation, most of the low power island logic blocks (other than memory) are able to work while providing good performance with nominal power consumption.

The hybrid GPU 210 supports dual mutually exclusive power delivery. In some aspects, a nominal power delivery rail 230 provides power to the standard AP 202, 3D rendering specific blocks 212, full memory 216, standard CP 220, 3D/2D rendering specific blocks 214, and memory subset 218. A low power delivery rail 240 provides power to the nano AP 204, 3D/2D rendering specific blocks 214, memory subset 218, and nano CP 222. In some aspects, some of the components operate exclusively in the low power domain. For example, the nano CP 22 may operate in only the low power domain, or a portion of the standard CP 220 may be power gated, while another portion of the standard CP 220 operates in the low power domain. A high-level shader processor and non-shader processor fixed function blocks may be supplied by the two different power rails. The non-shader processor fixed function blocks may run on either the nominal power level or the low power level.

In some implementations (not shown in FIG. 2), a single physical power rail is configurable to power the low power island and the nominal power island. In these implementations, the power rail has a selectable voltage level, such that a lower voltage may be selected to power the low power blocks or a higher voltage level may be selected to power the nominal power blocks.

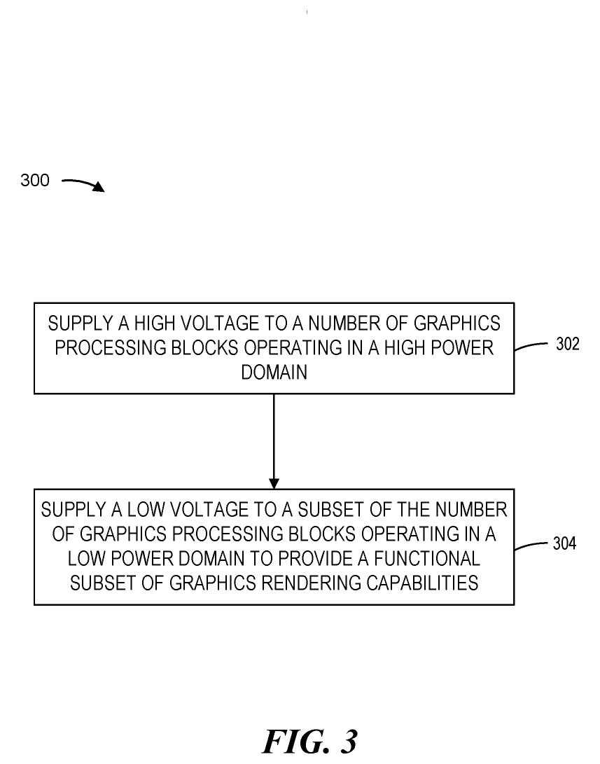

FIG. 3 is a flow diagram illustrating an example process 300 performed, for example, by a 3D GPU-based system, in accordance with various aspects of the present disclosure. The example process 300 is an example of hybrid power delivery-based graphics processing unit (GPU) architecture for ultra-low power, augmented reality (AR) wearable devices.

As shown in FIG. 3, in some aspects, the process 300 may include supplying a high voltage to a number of graphics processing blocks operating in a high power domain (block 302). In some aspects, the graphics processing blocks comprise three-dimensional (3D) processing blocks, an application processor, a control processor, and a memory.

In some aspects, the process 300 may include supplying a low voltage to a subset of the graphics processing blocks operating in a low power domain to provide a functional subset of graphics rendering capabilities (block 304). The subset of the graphics processing blocks may comprises 3D and two-dimensional (2D) processing blocks, a nano-application processor, a nano-control processor, and a memory subset.

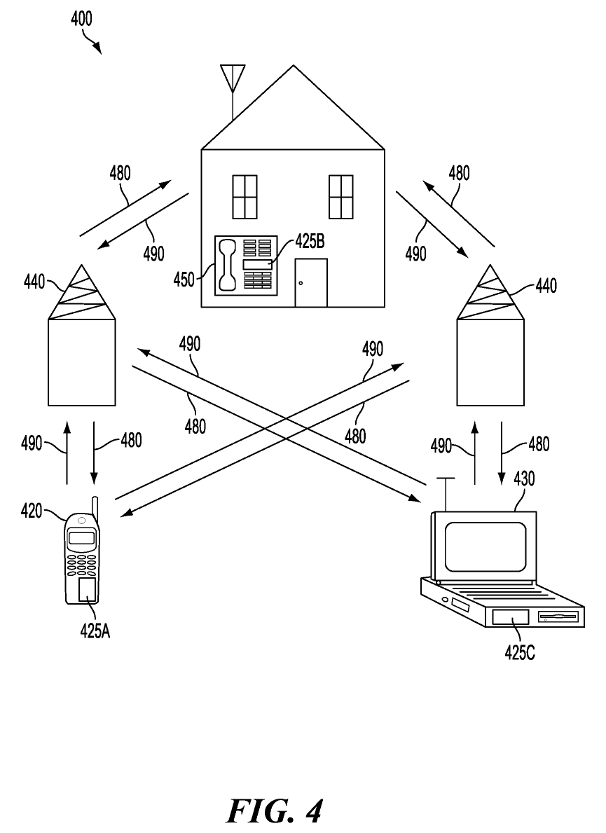

FIG. 4 is a block diagram showing an exemplary wireless communications system 400, in which an aspect of the present disclosure may be advantageously employed. For purposes of illustration, FIG. 4 shows three remote units 420, 430, and 450, and two base stations 440. It will be recognized that wireless communications systems may have many more remote units and base stations. Remote units 420, 430, and 450 include integrated circuit (IC) devices 425A, 425B, and 425C that include the disclosed 3D GPU-based system. It will be recognized that other devices may also include the disclosed 3D GPU-based system, such as the base stations, switching devices, and network equipment. FIG. 4 shows forward link signals 480 from the base stations 440 to the remote units 420, 430, and 450, and reverse link signals 490 from the remote units 420, 430, and 450 to the base stations 440.

In FIG. 4, remote unit 420 is shown as a mobile telephone, remote unit 430 is shown as a portable computer, and remote unit 450 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 4 illustrates remote units according to the aspects of the present disclosure, the disclosure is not limited to these exemplary illustrated units. Aspects of the present disclosure may be suitably employed in many devices, which include the disclosed 3D GPU-based system.

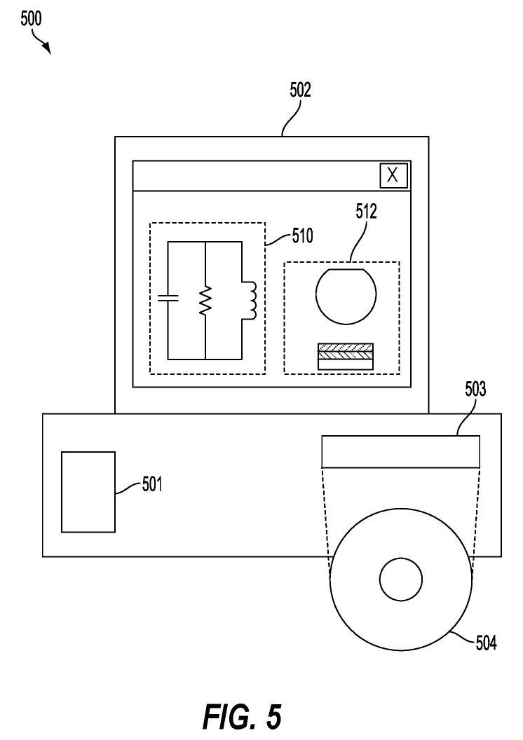

FIG. 5 is a block diagram illustrating a design workstation 500 used for circuit, layout, and logic design of a semiconductor component, such as the 3D GPU-based system disclosed above. The design workstation 500 includes a hard disk 501 containing operating system software, support files, and design software such as Cadence or OrCAD. The design workstation 500 also includes a display 502 to facilitate design of a circuit 510 or a semiconductor component 512, such as the 3D GPU-based system. A storage medium 504 is provided for tangibly storing the design of the circuit 510 or the semiconductor component 512 (e.g., the PLD). The design of the circuit 510 or the semiconductor component 512 may be stored on the storage medium 504 in a file format such as GDSII or GERBER. The storage medium 504 may be a CD-ROM, DVD, hard disk, flash memory, or other appropriate device. Furthermore, the design workstation 500 includes a drive apparatus 503 for accepting input from or writing output to the storage medium 504.

Data recorded on the storage medium 504 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 504 facilitates the design of the circuit 510 or the semiconductor component 512 by decreasing the number of processes for designing semiconductor wafers.

Aspect 1: A graphics processing unit (GPU) apparatus, comprising: a plurality of graphics processing blocks operating in a high power domain; and a subset of the plurality of graphics processing blocks operating in a low power domain to provide a functional subset of graphics rendering capabilities.

Aspect 2: The GPU apparatus of Aspect 1, integrated into an augmented reality (AR) device, a virtual reality (VR) device, a mobile device, or a wearable device.

Aspect 3: The GPU apparatus of Aspect 1 or 2, in which the plurality of graphics processing blocks comprises three-dimensional (3D) processing blocks and the subset of the plurality of graphics processing blocks comprises 3D and two-dimensional (2D) processing blocks.

Aspect 4: The GPU apparatus of any of the preceding Aspects, in which the plurality of graphics processing blocks further comprise an application processor, a control processor, and a memory, and the subset of the plurality of graphics processing blocks further comprise a nano-application processor, a nano-control processor, and a memory subset.

Aspect 5: The GPU apparatus of any of the preceding Aspects, in which the subset of the plurality of graphics processing blocks also operates in the high power domain.

Aspect 6: The GPU apparatus of any of the preceding Aspects, further comprising a low power rail supplying voltage to the low power domain, and a high power rail supplying voltage to the high power domain.

Aspect 7: The GPU apparatus of any of the preceding Aspects, in which the low power rail and the high power rail comprise a same physical line that switches between high power and low power.

Aspect 8: The GPU apparatus of any of the preceding Aspects, further configured to operate with an application programming interface (API) for the high power domain and operate with an API subset for the low power domain.

Aspect 9: A method of processing with a graphics processing unit (GPU) apparatus, comprising: supplying a high voltage to a plurality of graphics processing blocks operating in a high power domain; and supplying a low voltage to a subset of the plurality of graphics processing blocks operating in a low power domain to provide a functional subset of graphics rendering capabilities.

Aspect 10: The method of Aspect 9, performed in an augmented reality (AR) device, a virtual reality (VR) device, a mobile device, or a wearable device.

Aspect 11: The method of Aspect 9 or 10, in which the plurality of graphics processing blocks comprises three-dimensional (3D) processing blocks and the subset of the plurality of graphics processing blocks comprises 3D and two-dimensional (2D) processing blocks.

Aspect 12: The method of any of the Aspects 9-11, in which the plurality of graphics processing blocks further comprise an application processor, a control processor, and a memory, and the subset of the plurality of graphics processing blocks further comprise a nano-application processor, a nano-control processor, and a memory subset.

Aspect 13: The method of any of the Aspects 9-12, further comprising supplying the high voltage to the subset of the plurality of graphics processing blocks to operate in the high power domain.

Aspect 14: The method of any of the Aspects 9-13, further comprising switching a voltage level of a power rail for supplying high voltage to the high power domain, and low voltage to the low power domain.

Aspect 15: The method of any of the Aspects 9-14, further comprising communicating with an application programming interface (API) for high power domain operations and communicating with an API subset for low power domain operations.

Aspect 16: A graphics processing unit (GPU) apparatus, comprising: at least one memory; and at least one processor coupled to the at least one memory, the at least one processor configured: to supply a high voltage to a plurality of graphics processing blocks operating in a high power domain; and to supply a low voltage to a subset of the plurality of graphics processing blocks operating in a low power domain to provide a functional subset of graphics rendering capabilities.

Aspect 17: The apparatus of Aspect 16, with an augmented reality (AR) device.

Aspect 18: The apparatus of Aspect 16 or 17, in which the plurality of graphics processing blocks comprises three-dimensional (3D) processing blocks and the subset of the plurality of graphics processing blocks comprises 3D and two-dimensional (2D) processing blocks.

Aspect 19: The apparatus of any of the Aspects 16-18, in which the plurality of graphics processing blocks further comprise an application processor, a control processor, and a memory, and the subset of the plurality of graphics processing blocks further comprise a nano-application processor, a nano-control processor, and a memory subset.

Aspect 20: The apparatus of any of the Aspects 16-19, in which the at least one processor is further configured to supply the high voltage to the subset of the plurality of graphics processing blocks to operate in the high power domain.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray^{®} disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A graphics processing unit (GPU) apparatus, comprising:
a plurality of graphics processing blocks operating in a high power domain; and
a subset of the plurality of graphics processing blocks operating in a low power domain to provide a functional subset of graphics rendering capabilities.

2. The GPU apparatus of claim 1, integrated into an augmented reality (AR) device, a virtual reality (VR) device, a mobile device, or a wearable device.

3. The GPU apparatus of claim 1, in which the plurality of graphics processing blocks comprises three-dimensional (3D) processing blocks and the subset of the plurality of graphics processing blocks comprises 3D and two-dimensional (2D) processing blocks.

4. The GPU apparatus of claim 3, in which the plurality of graphics processing blocks further comprise an application processor, a control processor, and a memory, and the subset of the plurality of graphics processing blocks further comprise a nano-application processor, a nano-control processor, and a memory subset.

5. The GPU apparatus of claim 1, in which the subset of the plurality of graphics processing blocks also operates in the high power domain.

6. The GPU apparatus of claim 1, further comprising a low power rail supplying voltage to the low power domain, and a high power rail supplying voltage to the high power domain.

7. The GPU apparatus of claim 6, in which the low power rail and the high power rail comprise a same physical line that switches between high power and low power.

8. The GPU apparatus of claim 1, further configured to operate with an application programming interface (API) for the high power domain and operate with an API subset for the low power domain.

9. A method of processing with a graphics processing unit (GPU) apparatus, comprising:
supplying a high voltage to a plurality of graphics processing blocks operating in a high power domain; and
supplying a low voltage to a subset of the plurality of graphics processing blocks operating in a low power domain to provide a functional subset of graphics rendering capabilities.

10. The method of claim 9, performed in an augmented reality (AR) device, a virtual reality (VR) device, a mobile device, or a wearable device.

11. The method of claim 9, in which the plurality of graphics processing blocks comprises three-dimensional (3D) processing blocks and the subset of the plurality of graphics processing blocks comprises 3D and two-dimensional (2D) processing blocks.

12. The method of claim 11, in which the plurality of graphics processing blocks further comprise an application processor, a control processor, and a memory, and the subset of the plurality of graphics processing blocks further comprise a nano-application processor, a nano-control processor, and a memory subset.

13. The method of claim 9, further comprising supplying the high voltage to the subset of the plurality of graphics processing blocks to operate in the high power domain.

14. The method of claim 9, further comprising switching a voltage level of a power rail for supplying the high voltage to the high power domain, and the low voltage to the low
power domain.

15. The method of claim 9, further comprising communicating with an application programming interface (API) for high power domain operations and communicating with an API subset for low power domain operations.

16. A graphics processing unit (GPU) apparatus, comprising:
at least one memory; and
at least one processor coupled to the at least one memory, the at least one processor configured:
to supply a high voltage to a plurality of graphics processing blocks operating in a high power domain; and
to supply a low voltage to a subset of the plurality of graphics processing blocks operating in a low power domain to provide a functional subset of graphics rendering capabilities.

17. The apparatus of claim 16, within in an augmented reality (AR) device, a virtual reality (VR) device, a mobile device, or a wearable device.

18. The apparatus of claim 16, in which the plurality of graphics processing blocks comprises three-dimensional (3D) processing blocks and the subset of the plurality of graphics processing blocks comprises 3D and two-dimensional (2D) processing blocks.

19. The apparatus of claim 18, in which the plurality of graphics processing blocks further comprise an application processor, a control processor, and the at least one memory further comprises a high power memory, and the subset of the plurality of graphics processing blocks further comprise a nano-application processor, a nano-control processor, and the at least one memory further comprises a memory subset.

20. The apparatus of claim 16, in which the at least one processor is further configured to supply the high voltage to the subset of the plurality of graphics processing blocks to operate in the high power domain.
